(19) United States
(12) Patent Application Publication
(10) Pub. No.: US 2026/0076378 A1
(43) Pub. Date: Mar. 19, 2026

(54) Pre-Applied Chocolate-Coated Cracker Food Product

(71) Applicant: Monica Jones, Tonopah, AZ (US)

(72) Inventor: Monica Jones, Tonopah, AZ (US)

(21) Appl. No.: 19/332,110

(22) Filed: Sep. 18, 2025

Related U.S. Application Data
(60) Provisional application No. 63/696,532, filed on Sep. 19, 2024.

(51) Int. Cl. A21D 13/28; A21D 13/40; A23G 1/50

(52) U.S. Cl. CPC A21D 13/28; A21D 13/40; A23G 1/507

(57) ABSTRACT

The present invention relates to a chocolate layer integrated cracker food product. The cracker food product includes a cracker base with a pre-applied chocolate layer on one surface, which remains stable at room temperature but melts when exposed to the heat of a roasted marshmallow. The chocolate layer extends across the cracker base to provide even chocolate distribution. In some embodiments, the chocolate layer features a micro-textured surface to enhance heat conduction and controlled melting. An alternative embodiment includes discrete chocolate pieces adhered to the cracker, which melt upon contact with a hot marshmallow. The invention also includes a s'mores food item formed by placing a roasted marshmallow between two chocolate-layered crackers.

### CROSS-REFERENCE TO RELATED APPLICATION

The present application claims priority to, and the benefit of, U.S. Provisional Application No. 63/696,532, which was filed on Sep. 19, 2024, and is incorporated herein by reference in its entirety.

### FIELD OF THE INVENTION

The present invention generally relates to food products. More specifically, the invention relates to a chocolate layer integrated cracker food product that simplifies the traditional s'mores-making process by incorporating a pre-applied chocolate layer on one surface of a cracker, such as a graham cracker. The integrated chocolate layer provides consistent melting when exposed to the heat of a roasted marshmallow, eliminating the need for separately handling chocolate pieces. Alternative embodiments may include discrete chocolate pieces adhered to the cracker, allowing for a controlled melting experience. Accordingly, the present disclosure makes specific reference thereto. Nonetheless, it is to be appreciated that aspects of the present invention are also equally applicable to other like applications, devices, and methods of manufacture.

### BACKGROUND

By way of background, both children and adults enjoy making s'mores, which traditionally consist of three primary ingredients: graham crackers, chocolate, and roasted marshmallows. The process of making s'mores involves roasting a marshmallow over an open flame, then carefully placing it between two graham crackers with a piece of chocolate to create the final treat. However, the traditional method of making s'mores is often challenging for many individuals.

One of the most common issues is that the chocolate does not always melt properly when sandwiched between the crackers and marshmallows, leading to an inconsistent texture and taste. Additionally, holding the chocolate in place while assembling the smore can be difficult, especially when dealing with uneven melting, shifting ingredients, or chocolate pieces that slide out of place. To address these inconveniences, people desire an improved cracker food item that saves considerable time and effort when making s'mores.

Therefore, there exists a long-felt need in the art for a s'mores-making solution that simplifies the preparation process and enhances the overall experience. There is a long-felt need for a chocolate-integrated graham cracker that eliminates the need to manually add chocolate. Additionally, there is a long-felt need for a mess-free alternative that prevents chocolate from slipping out of place or remaining solid while eating. Furthermore, there exists a long-felt need in the art for a s'mores food item that improves convenience, particularly for children, campers, and individuals seeking a quick and easy dessert preparation method. More specifically, there exists a long-felt need for a graham cracker with a pre-applied chocolate layer that melts efficiently when exposed to the heat of a roasted marshmallow, eliminating the inconsistency of traditional chocolate bars. Also, there is a long-felt need in the art for a chocolate-coated graham cracker with an optimized melting temperature. Finally, there is a long-felt need for an improved s'mores-making method that saves considerable time and effort when making s'mores by skipping the chocolate application and melting step.

The subject matter disclosed and claimed herein, in one embodiment, comprises a pre-applied chocolate layer cracker food product. The product includes a graham cracker base with a first and second surface, wherein a pre-applied chocolate layer is disposed on the second surface. The chocolate layer remains stable at room temperature but is specifically formulated to melt upon contact with a hot, roasted marshmallow. The chocolate layer allows for complete coverage and even distribution of melted chocolate throughout the s'mores. In some embodiments, the chocolate layer may feature a micro-textured surface to enhance heat conduction, improve melting efficiency, and provide an optimal balance of flavors.

In this manner, the chocolate layer integrated cracker food product of the present invention fulfills the long-felt need for a more efficient, mess-free, and convenient way to prepare s'mores. The product integrates the chocolate layer directly onto the graham cracker to eliminate the need for separate chocolate bars, thereby providing consistent chocolate melting and flavor balance in every bite. The product enhances the traditional s'mores experience by preventing ingredient shifting and uneven melting, making it ideal for camping, family gatherings, and quick at-home preparation. Furthermore, the invention supports various chocolate thicknesses and flavors, allowing users to customize their s'mores experience based on personal taste preferences.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a chocolate layer integrated cracker food product. The food product comprises a cracker food item having a first surface and an opposite second surface, a chocolate layer is disposed on said second surface, wherein the chocolate layer is configured to melt when exposed to the heat of a roasted marshmallow. The chocolate layer extends across at least two opposite edges of the cracker food item to ensure even chocolate distribution when melted.

In another aspect, a chocolate layer integrated cracker food product is disclosed. The chocolate layer integrated cracker food product includes a cracker food item having a first surface and an opposite second surface, a chocolate layer is disposed on said second surface, wherein the chocolate layer remains stable at room temperature, melts at a temperature between 145° F. and 160° F., corresponding to the temperature of a freshly roasted marshmallow, providing a uniform, gooey consistency in every bite and wherein said chocolate layer has a thickness between 0.5 mm and 4 mm, such that the melting rate varies based on thickness.

In one embodiment, a s'mores food item is disclosed. The food item comprises a first cracker food item having a first surface and an opposite second surface, wherein the second surface includes a pre-applied chocolate layer that is configured to melt upon exposure to heat, a second cracker food item having a first surface and an opposite second surface, wherein the second surface includes a pre-applied chocolate layer, a roasted marshmallow is positioned between the second surfaces of the first and second cracker food items, such that the marshmallow directly contacts the pre-applied chocolate layers and transfers heat to melt the chocolate layers, wherein the chocolate layers have a melting point between 145° F. and 160° F. for uniform melting and an even distribution of chocolate throughout the s'mores food item.

In yet another aspect, a chocolate layer integrated cracker food product is disclosed. The chocolate layer integrated cracker food product comprises a cracker food item having a first surface and an opposite second surface, a plurality of discrete chocolate pieces adhered to said second surface, wherein: said chocolate pieces remain solid at room temperature, said chocolate pieces are spaced apart to allow heat penetration and controlled melting when a roasted marshmallow is placed in contact with them, and wherein said chocolate pieces are configured to provide a balanced taste experience of chocolate, marshmallow, and cracker upon melting.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of the chocolate layer integrated cracker food product of the present invention in accordance with the disclosed structure;

FIG. 2 illustrates another perspective view of the cracker food item of the present invention in accordance with the disclosed structure;

FIG. 3 illustrates a perspective view of a s'mores food item created using the cracker food product in accordance with one embodiment of the present invention;

FIG. 4 illustrates another embodiment of the chocolate layer in accordance with the disclosed structure; and

FIG. 5 illustrates a flow chart depicting a process of making a food item using the cracker food product of the present invention in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a s'mores-making solution that simplifies the preparation process and enhances the overall experience. There is a long-felt need for a chocolate-integrated graham cracker that eliminates the need to manually add chocolate. Additionally, there is a long-felt need for a mess-free alternative that prevents chocolate from slipping out of place or remaining solid while eating. Furthermore, there exists a long-felt need in the art for a s'mores food item that improves convenience, particularly for children, campers, and individuals seeking a quick and easy dessert preparation method. More specifically, there exists a long-felt need for a graham cracker with a pre-applied chocolate layer that melts efficiently when exposed to the heat of a roasted marshmallow, eliminating the inconsistency of traditional chocolate bars. Also, there is a long-felt need in the art for a chocolate-coated graham cracker with an optimized melting temperature. Finally, there is a long-felt need for an improved s'mores-making method that saves considerable time and effort when making s'mores by skipping the chocolate application and melting step.

The present invention, in one exemplary embodiment, is a s'more food item. The food item comprises a first cracker food item having a first surface and an opposite second surface, wherein the second surface includes a pre-applied chocolate layer that is configured to melt upon exposure to heat, a second cracker food item having a first surface and an opposite second surface, wherein the second surface includes a pre-applied chocolate layer, a roasted marshmallow is positioned between the second surfaces of the first and second cracker food items, such that the marshmallow directly contacts the pre-applied chocolate layers and transfers heat to melt the chocolate layers, wherein the chocolate layers have a melting point between 145° F. and 160° F. for uniform melting and an even distribution of chocolate throughout the s'more food item.

Reference will now be made in detail to the present preferred embodiments of the invention, examples of which are illustrated in the accompanying drawings. Wherever possible, the same reference numerals are used in the drawings and the description to refer to the same or like parts.

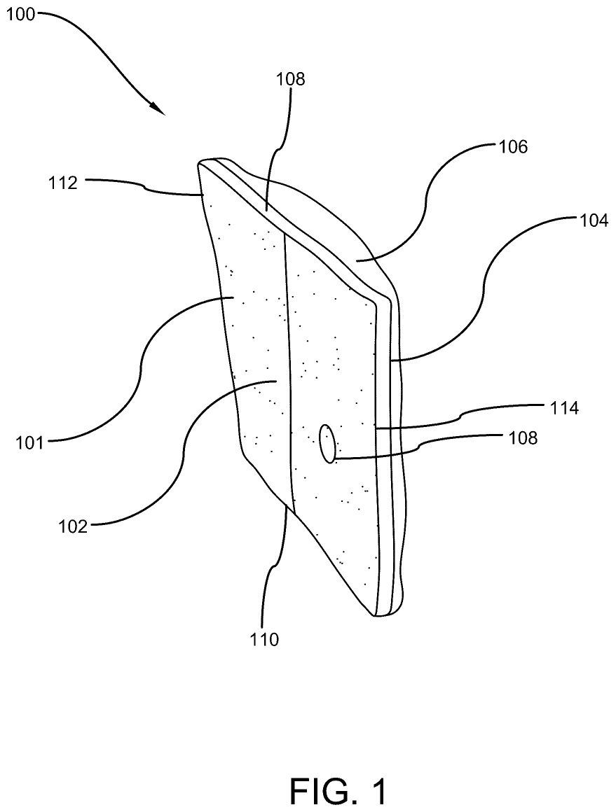

Referring initially to the drawings, FIG. 1 illustrates a perspective view of chocolate layer integrated cracker food product 100 in accordance with the disclosed structure. The pre-applied chocolate-coated cracker food product 100 is a specialized graham cracker product designed to simplify the process of making s'mores by integrating a pre-applied chocolate layer on one side of cracker food item 100. As a result, cracker food product 100 eliminates the need for separately adding chocolate pieces, thereby making the s'mores-making experience more convenient, efficient, and less messy. Additionally, the integrated the chocolate layer 106 improves structural stability, preventing chocolate slippage or uneven distribution when heat is applied.

More specifically, chocolate layer integrated cracker food product 100 includes a cracker food item 101 having a first surface 102 and an opposite second surface 104. The cracker food item 101 is preferably and generally rectangular or square but can be of any geometric shape. Cracker food item 101 can also be in different shapes, such as logos, characters, letters, etc. The cracker food item 101 is preferably a whole wheat sweet cracker, a digestive biscuit, a wheat cracker, etc. A thin and even chocolate layer or coating 106 is disposed on the second surface 104. The chocolate layer 106 is configured to melt when exposed to the heat of a roasted marshmallow. The chocolate layer 106 extends across the pair of edges 108, 110 and 112, 114, respectively, of cracker food item 101. In some embodiments, the chocolate layer 106 may wrap slightly around the edges to enhance adhesion to cracker food item 101, minimizing flaking or separation during handling. In a further embodiment, the cracker food item 101 is comprised of a caramel layer 107 in addition to or in alternative to the chocolate layer 106.

The chocolate layer 106 remains stable at room temperature but melts rapidly at around 145-160° F. (the temperature of a freshly roasted marshmallow), allowing uniform melting of the chocolate layer 106, providing an even, gooey consistency in every bite. The melting characteristics of the chocolate layer 106 may be adjusted through the incorporation of an additive 107 such as, but not limited to, cocoa butter or emulsifiers, ensuring controlled melting rates for different consumer preferences. It is also contemplated that the chocolate used could be imitation chocolate or cholate flavored substitutes. Table 1 below provides various thicknesses of chocolate layer 106 in accordance with different embodiments of the disclosed structure.

TABLE 1

| | Melting time with | |
|---|---|---|
| Component | Marshmallow | Taste Specifics |
| 0.5 mm-1 mm | Fast Melting | Subtle chocolate flavor |
| | (5-10 seconds) | |
| 1 mm-2.5 mm | Medium melting | Balanced chocolate, graham, |
| | (10-15 sec) | and marshmallow flavor |
| 2.5 mm-4 mm | Slow melting | Rich, dominant chocolate |
| | (15-30 sec) | flavor |

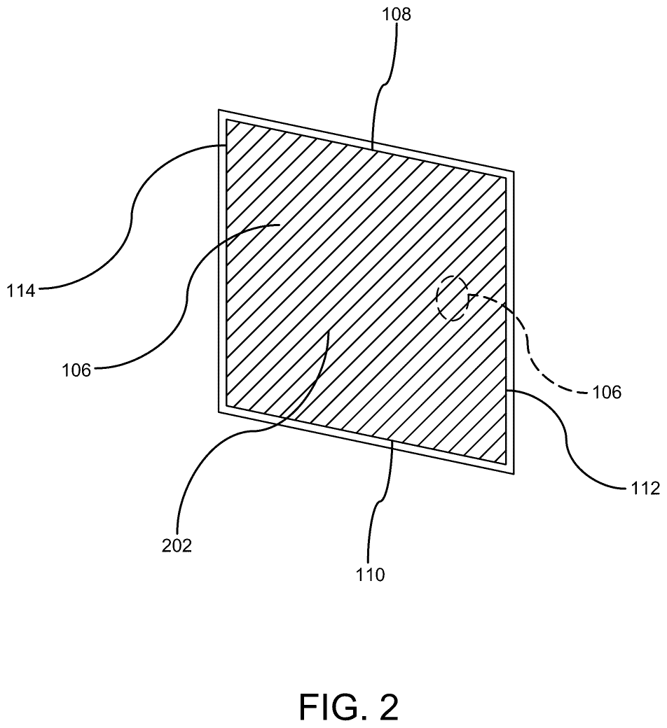

FIG. 2 illustrates another perspective view of cracker food item 100 in accordance with the disclosed structure. As illustrated in the bottom perspective view, the chocolate layer 106 may be comprised of a micro-textured surface 202, which helps in increasing surface area for better heat conduction, even melting, and enhancing flavor distribution. The micro-texturing may include raised dots, waves, or grid patterns to regulate the flow of melted chocolate, ensuring a consistent spread over the marshmallow. In some embodiments, surface 202 is in the form of ridges or patterns that channel melted chocolate toward the marshmallow when the chocolate layer 106 is melted using the heat of the roasted marshmallow.

The chocolate layer 106 can be made in different flavors, including, but not limited to, milk chocolate, dark chocolate, or white chocolate variants. Further, cracker food item 101 can be infused with a flavor 103 such as, but not limited to, cinnamon, honey, vanilla, or any other flavor, for accommodating the tastes of different users. In some embodiments, cracker food item 101 may have a lightly caramelized surface to enhance crunch and complement the melting the chocolate layer 106. Chocolate layer integrated cracker food product 100 can be made in different sizes and can also be designed in bite-sized versions for quick consumption without the need for roasting.

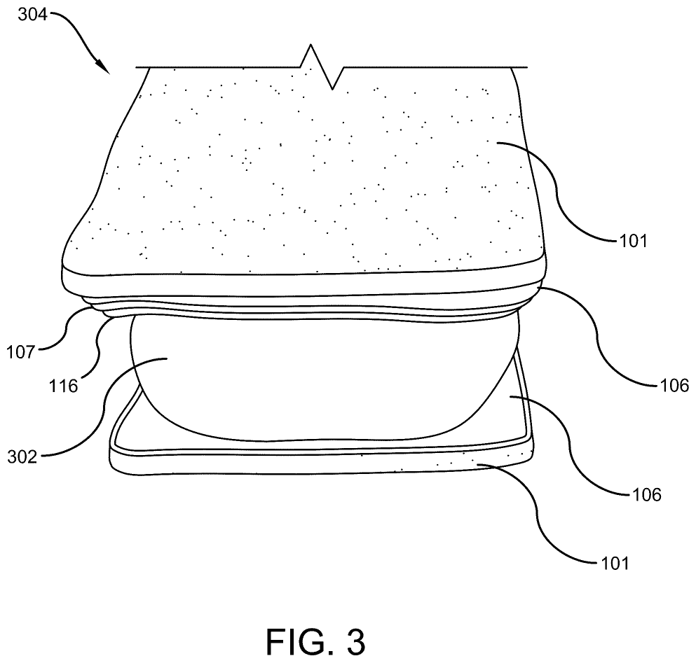

FIG. 3 illustrates a perspective view of a s'mores food item 304 created using cracker food product 100 in accordance with one embodiment of the disclosed structure. As illustrated, a hot and roasted marshmallow 302 is placed directly between the two chocolate-coated sides 104 of cracker food item 101 such that marshmallow 302 is in contact with chocolate layers 106. The direct contact of marshmallow 302 and coatings 106 transfers heat from marshmallow 302 to begin melting of chocolate layer 106. Depending on the thickness of the chocolate layer 106, the chocolate layer 106 can be melted from about 5 seconds to about 30 seconds. S'mores 304 has a uniform mixture of marshmallow 302 and chocolate and eliminates the requirement of applying separate chocolate bars. Additionally, the chocolate layer 106 prevents excessive marshmallow seepage, maintaining a cleaner eating experience.

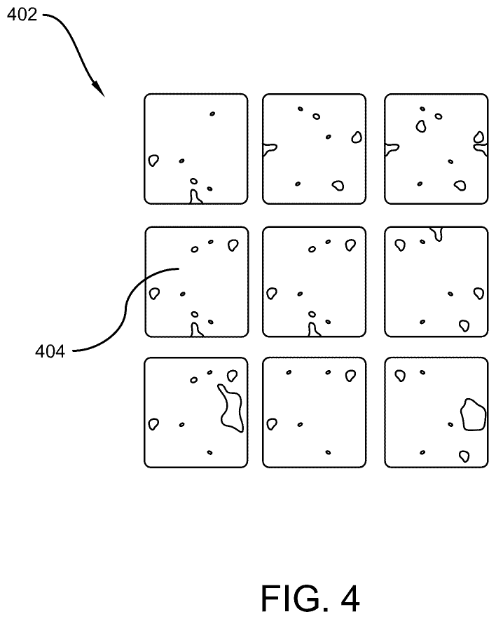

FIG. 4 illustrates another embodiment of the chocolate layer 106 in accordance with the disclosed structure. In the present embodiment, chocolate layer 402 is in the form of small and independent (e.g., non-continuous) chocolate pieces 404 and is configured to provide a balanced taste of marshmallow, chocolate, and cracker food items (such as, but not limited to, a graham cracker). Chocolate pieces 404 adhere to cracker food items and do not melt at room temperature. The arrangement of chocolate pieces 404 can vary, including uniform spacing, clustered sections, or embedded chips, etc., offering distinct textural experiences.

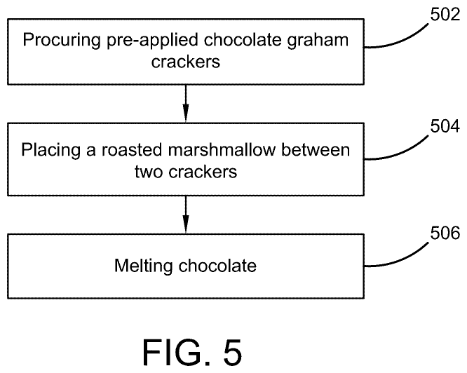

FIG. 5 illustrates a flow chart depicting a process of making a food item using cracker food product 100 in accordance with the disclosed structure. Initially, one or more graham cracker products 100 are procured for making the food items, such as a s'mores food item (Step 502). The cracker products are positioned such that the chocolate-coated sides face each other. Then, a roasted marshmallow is put directly between the chocolate-coated sides of the graham cracker products (Step 504). It should be noted that a campfire, stovetop, or microwave may be used for heating the marshmallow for use with the food cracker products. In some variations, additional ingredients 116 such as caramel drizzle, peanut butter, or fruit preserves may be added between marshmallow 302 and chocolate layers 106 for enhanced flavor profiles. Thereafter, the chocolate layers are melted, and the food item is consumed by a user (Step 506). The food item can be eaten open-faced like a cookie with a melted chocolate and marshmallow topping. Alternatively, food product 100 may be cooled slightly before consumption to achieve a firmer texture while retaining a partially melted the chocolate layer 106.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein, “chocolate-integrated graham cracker”, “pre-applied chocolate-coated cracker food product”, “chocolate layer integrated cracker food product”, “chocolate layer integrated cracker graham cracker”, and “graham cracker” are interchangeable and refer to the pre-applied chocolate-coated cracker food item 100 of the present invention.

Notwithstanding the foregoing, the pre-applied chocolate-coated cracker food item 100 of the present invention can be of any suitable configuration as is known in the art without affecting the overall concept of the invention, provided that it accomplishes the above-stated objectives. One of ordinary skill in the art will appreciate that the pre-applied chocolate-coated cracker food item 100 as shown in the FIGS. are for illustrative purposes only, and that many other configurations of the pre-applied chocolate-coated cracker food item 100 are well within the scope of the present disclosure. Although the dimensions of the pre-applied chocolate-coated cracker food item 100 are important design parameters for user convenience, the pre-applied chocolate-coated cracker food item 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A chocolate layer integrated cracker food product comprising:
a cracker having a first surface and a second surface opposite the first surface; and
a chocolate layer disposed on the second surface, wherein the chocolate layer is configured to melt when exposed to a heat.

2. The chocolate layer integrated cracker food product of claim 1, wherein the chocolate layer extends across a pair of edges of the cracker.

3. The chocolate layer integrated cracker food product of claim 1, wherein the chocolate layer melts at a temperature between 145° F. to 160° F.

4. The chocolate layer integrated cracker food product of claim 1, wherein the chocolate layer is comprised of an additive comprised of a cocoa butter.

5. The chocolate layer integrated cracker food product of claim 1, wherein the chocolate layer is comprised of an additive comprised of an emulsifier.

6. The chocolate layer integrated cracker food product of claim 1, wherein the chocolate layer is comprised of a milk chocolate, a dark chocolate, or a white chocolate.

7. The chocolate layer integrated cracker food product of claim 1, wherein the cracker is comprised of an infused flavor.

8. The chocolate layer integrated cracker food product of claim 7, wherein the infused flavor is comprised of a cinnamon, a honey, or a vanilla.

9. The chocolate layer integrated cracker food product of claim 7, wherein the chocolate layer is non-continuous across the cracker.

10. A chocolate layer integrated cracker food product comprising:
a cracker having a first surface and a second surface opposite the first surface; and
a chocolate layer disposed on the second surface, wherein the chocolate layer is configured to melt when exposed to a heat and is comprised of a textured surface.

11. The chocolate layer integrated cracker food product of claim 10, wherein the textured surface is comprised of a raised dot, a wave, or a grid pattern.

12. The chocolate layer integrated cracker food product of claim 10 further comprising a caramel.

13. The chocolate layer integrated cracker food product of claim 10 further comprising a peanut butter.

14. The chocolate layer integrated cracker food product of claim 10 further comprising a fruit preserve.

15. The chocolate layer integrated cracker food product of claim 10, wherein the chocolate layer extends across a pair of edges of the cracker.

16. The chocolate layer integrated cracker food product of claim 10, wherein the chocolate layer melts at a temperature between 145° F. to 160° F.

17. The chocolate layer integrated cracker food product of claim 10, wherein the chocolate layer is comprised of an additive comprised of a cocoa butter.

18. The chocolate layer integrated cracker food product of claim 10, wherein the chocolate layer is comprised of an additive comprised of an emulsifier.

19. The chocolate layer integrated cracker food product of claim 10, wherein the cracker is comprised of an infused flavor comprised of a cinnamon, a honey, or a vanilla.

20. A method of making a chocolate layer integrated cracker food product, the method comprising the following steps:
providing a first cracker comprised of a first surface and having a chocolate layer disposed on a second surface;
positioning a heated marshmallow between the first cracker and a second cracker such that the first chocolate layer and a second chocolate layer of the second cracker face the marshmallow; and
allowing a heat from the marshmallow to melt the first chocolate layer and the second chocolate layer to form the food item.
